(19) United States
(12) Patent Application Publication
(10) Pub. No.: US 2026/0350550 A1
(43) Pub. Date: Nov. 5, 2026

(54) PREDICTING MAINTENANCE OPERATIONS FOR AIRCRAFT

(71) Applicant: CAMP Systems International, Inc., Merrimack, NH (US)

(72) Inventors: Jason W. Buhro, Austin, TX (US); Peter Velikin, Boston, MA (US); Shahansha Salim, Bangalore (IN); Ankit Kumar, Kottayam (IN); Prakash Manden, Brookline, NH (US)

(21) Appl. No.: 19/195,360

(22) Filed: Apr. 30, 2025

(51) Int. Cl. G06Q 10/20

(52) U.S. Cl. CPC G06Q 10/20

(57) ABSTRACT

A device receives a data query from a source, the data query associated with a hardware component. The device determines a likelihood that an aircraft of an aircraft entity associated with the data query will require the hardware component by retrieving a plurality of signals received from the aircraft entity that are associated with the hardware component, applying the plurality of signals to a first machine-learned model, and receiving, as output from the first machine-learned model, a likelihood that the aircraft will require the hardware component. The device inputs the likelihood into a second machine-learned model, and receives as output a score corresponding to the data query. The device assigns a rank to the data query based on its score as compared to scores of other data queries of a plurality of data queries, and displays an ordered list of the plurality of data queries.

### TECHNICAL FIELD This disclosure generally relates to the field of aircraft maintenance, and more specifically relates to predicting (e.g., unscheduled) maintenance operations for an aircraft.

### BACKGROUND

An aircraft service provider performs maintenance operations on an aircraft according to a maintenance schedule. The maintenance schedule is defined by a service manual for that aircraft. The maintenance schedule specifies which maintenance operations should be performed during different maintenance sessions.

### SUMMARY

If a maintenance operation is not specified in the service manual, it is unclear if that maintenance operation should ever be performed on an aircraft. Furthermore, during a given maintenance session, it is unclear if any maintenance operations not specified in the maintenance schedule for that session should be performed. While an aircraft service provider can review maintenance notes in service reports or work orders to determine maintenance operations to perform during a maintenance session (outside of the maintenance operations already listed in a maintenance schedule), service reports and work orders are often scattered across many different databases, and some of these databases may be unknown to the service provider. Furthermore, service reports and work orders are not normalized. For example, individual service reports and work orders may provide information using different formats, such as images, audio, videos, typed text, or handwritten text. Furthermore, service reports and work orders do not often use consistent terminology, phraseology, or formatting (e.g., technicians may use different terms and phraseologies to describe the same or similar maintenance operations). Thus making it difficult to determine which maintenance operations should be performed outside of the maintenance schedule.

To address these problems, this disclosure describes an aircraft maintenance module that may aggregate maintenance operations from service manuals, work orders, and service reports for aircraft (e.g., from a large set of diverse databases); normalize the maintenance operations; deduplicate the maintenance operations (even if different terminologies or phraseologies are used); determine correlations between the maintenance operations; and provide maintenance operation recommendations based on the correlations. This enables the aircraft maintenance module to predict and recommend unscheduled maintenance operations to perform (e.g., maintenance operations that are not expected or unintuitive to perform during a given maintenance session). Additional advantages and uses of the aircraft maintenance module are described in the detailed description.

Systems and methods are disclosed herein for predicting aircraft maintenance operations. A set of maintenance operation descriptors relating to maintenance for an aircraft is received. The set of maintenance operation descriptors are transformed into a plurality of maintenance operation embedding vectors. A set of known maintenance operations are determined by applying each maintenance operation embedding vector into an unsupervised machine learning model. Each known maintenance operation of the set of known maintenance operations relates to maintenance for the aircraft and is associated with a cluster of a graph that correlates clusters. A plurality of resultant maintenance operations are determined using weights of the graph that correlates clusters. Each of the plurality of resultant maintenance operations have at least a threshold correlation to at least one maintenance operation of the set of known maintenance operations. An aircraft maintenance recommendation comprising at least one of the plurality of resultant maintenance operations is output.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for implementing an aircraft maintenance module.

FIG. 2 illustrates one embodiment of exemplary modules and databases used by the aircraft maintenance module.

FIG. 3A illustrates one embodiment of an exemplary data flow for generating a graph object using modules of the aircraft maintenance module.

FIG. 3B illustrates one embodiment of an exemplary data flow for generating a maintenance recommendation for an aircraft using modules of the aircraft maintenance module.

FIG. 4 is a block diagram illustrating components of an example machine able to read instructions from a machine-readable medium and execute them in a processor (or controller).

FIG. 5 illustrates a flow chart for an exemplary process for generating an aircraft maintenance recommendation.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### AIRCRAFT MAINTENANCE MODULE—EXEMPLARY SYSTEM ENVIRONMENT

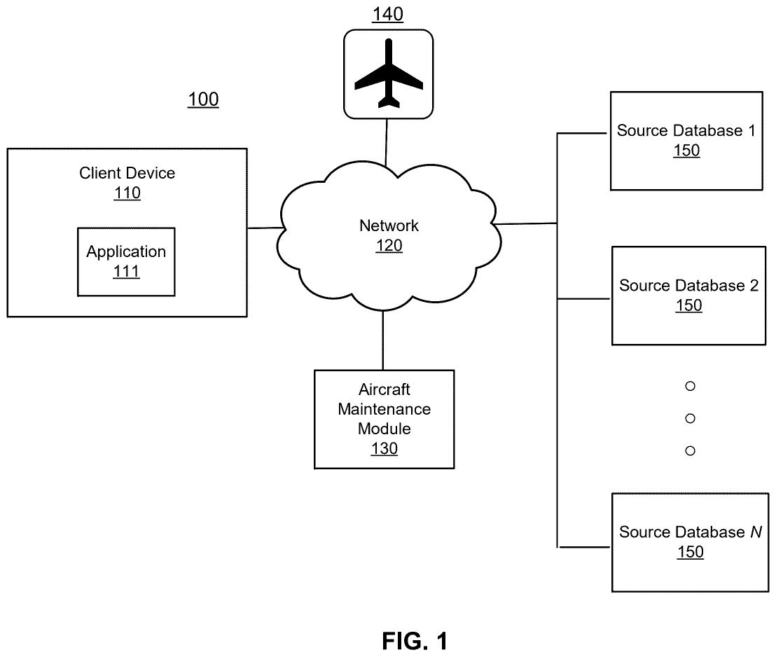

Figure (FIG.) 1 illustrates one embodiment of a system environment for implementing aircraft maintenance module. As depicted in FIG. 1, system 100 includes a client device 110 with application 111 installed thereon, a network 120, an aircraft maintenance module 130, source databases 150, and an aircraft entity 140. The client device 110 may be any device configured to receive input from a user and communicate with the aircraft maintenance module 130. Exemplary client devices include personal computers, smartphones, tablets, Internet-of-Things (IoT) devices, laptops, kiosks, and so on. Communications between client device 110 and aircraft maintenance module 130 may be managed by application 111.

Application 111 may be a specialized application (e.g., downloaded from aircraft maintenance module 130 or provided by aircraft maintenance module 130 for download through a third-party system), or may be accessed through a browser installed on client device 110. Application 111 may operate differently depending on credentials of a user operating the client device 110. For example, the application 111 may operate to receive input from a user who performs maintenance operations on aircraft and may operate to display recommendations for performing maintenance operations on aircraft.

Network 120 may be any network that transmits data communications between at least client device 110 and aircraft maintenance module 130. Network 120 may transmit data communications between any entity shown in FIG. 1, as well as any entity discussed herein but not shown in FIG. 1. Exemplary data networks include the Internet, a wide area network, a local area network, a WiFi network, and any other network that transfers data between electronic devices.

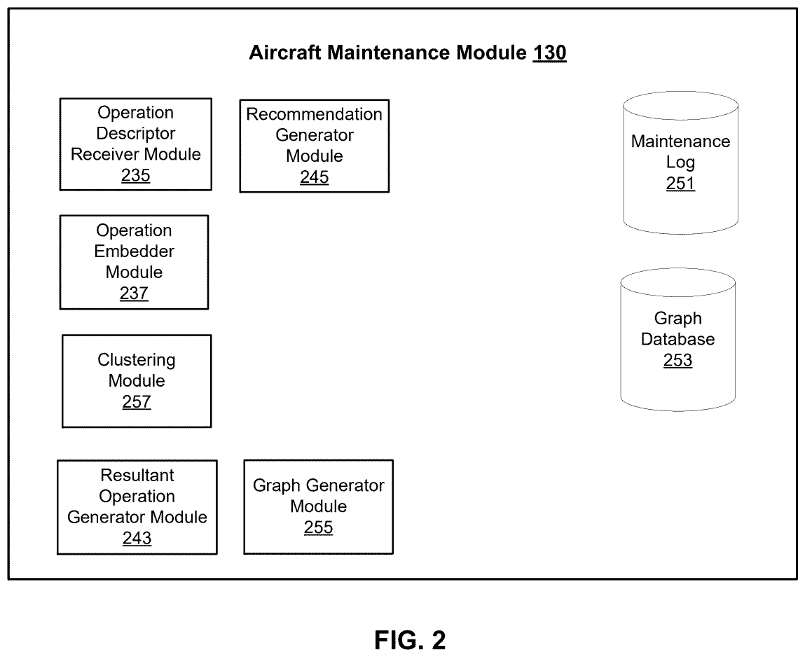

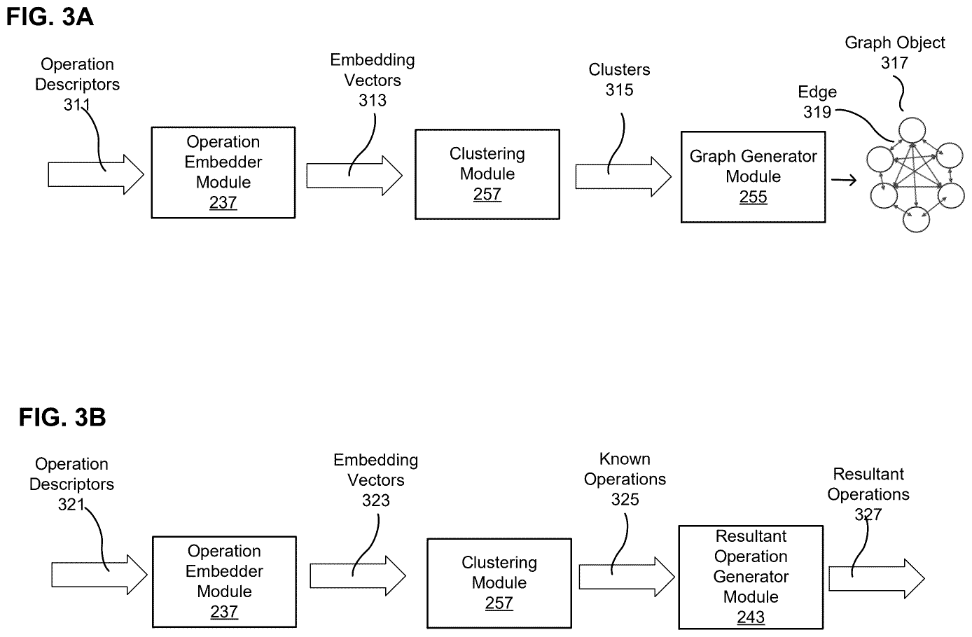

Aircraft maintenance module 130 can receive signals related to an aircraft (e.g., maintenance operation descriptors) from entities (e.g., application 111) and determine a maintenance recommendation for that aircraft (e.g., one or more additional maintenance operations to perform on the aircraft). Further details of aircraft maintenance module 130 are described below with respect to FIGS. 2-3B.

Aircraft entity 140 may be an aircraft that stores and communicates information about one or more aircraft. The Aircraft entity 140 may transmit signals to the aircraft maintenance module 130. These signals may be transmitted directly or may be transmitted using network 120.

Source databases 150 house data relating to maintenance operations (e.g., service reports and work orders) and can provide this data to aircraft maintenance module 130 (e.g., via network 120).

### AIRCRAFT MAINTENANCE MODULE—MODULES AND DATABASES

FIG. 2 illustrates one embodiment of exemplary modules and databases used by the aircraft maintenance module 130. As depicted in FIG. 2, the aircraft maintenance module 130 includes an operation descriptor receiver module 235, an operation embedder module 237, a clustering module 257, a resultant operation generator module 243, a recommendation generator module 245, a graph generator module 255, a maintenance log 251, and a graph database 253. The modules and databases depicted in FIG. 2 are merely exemplary; fewer or more modules and/or databases may be used to achieve the functionality described herein. Moreover, some or all functionality of aircraft maintenance module 130 may be distributed and/or instantiated at client device 110 (e.g., on application 111), at aircraft entity 140, at one or more of the source databases 150, or any combination thereof.

The aircraft maintenance module 130 may generate maintenance operation recommendations for a user (e.g., an individual (e.g., a technician or mechanic), a maintenance entity (e.g., company), or an airline). For example, if a user provides a description of a scheduled maintenance operation (e.g., via client device 110) the plan to perform on an aircraft (e.g., aircraft entity 140), the aircraft maintenance module 130 can recommend additional maintenance operations (e.g., unscheduled maintenance operations) to be performed. Among other advantages, the recommendation generation can help users maintain aircraft (e.g., aircraft entity 140). Modules of the aircraft maintenance module 130 used to generate a recommendation include the operation descriptor receiver module 235, the operation embedder module 237, the clustering module 257, the resultant operation generator module 243, and the recommendation generator module 245 (e.g., see FIG. 3B and associated description).

In addition to, or alternative to, generating maintenance operation recommendations, the aircraft maintenance module 130 may generate graph objects that correlate maintenance operations to each other (e.g., see description with respect to the graph generator module 255 and FIG. 3A and its description). These graph objects may be used to generate maintenance operation recommendations. Modules of the aircraft maintenance module 130 that may be used to generate a graph object include the operation descriptor receiver module 235, the operation embedder module 237, the clustering module 257, and the graph generator module 255 (e.g., see FIG. 3A and associated description).

A “maintenance session” for an aircraft may refer to a session or period of time for the inspection, repair, servicing, and maintenance of an aircraft to help ensure its functionality, safety, and regulatory compliance. A maintenance session can include maintenance operations such as parts replacement, general inspection, fixing technical issues, engine servicing, correcting anomalies, system updates, and other preventative and corrective actions to maintain the aircraft in a state of operational readiness. Maintenance sessions may be planned in advance and may be part of the routine aircraft lifecycle. A maintenance session for an aircraft may be scheduled based on flight hours, calendar days, or usage cycles of the aircraft. A maintenance session can also be reactive (e.g., carried out in response to an issue or fault detected). The aim of any maintenance session is to preserve the aircraft's integrity, increase its longevity, sustain its performance, and help ensure the safety of its passengers and crew.

In the context of aircraft maintenance, a “operation” or “maintenance operation” may refer to a specific maintenance activity or task performed on an aircraft during a maintenance session. An operation may relate to maintaining, repairing, or inspecting the aircraft (or any combination thereof). Maintenance operations can vary in their complexity, ranging from straightforward actions such as tire checks and oil changes, to more intricate procedures like engine inspections or avionic system updates. An operation may be performed following regulatory guidelines and standards to help ensure the aircraft remains functional. Furthermore, an operation may be documented in a service report or work order (e.g., after the maintenance operation is performed).

A “scheduled maintenance operation” or “scheduled operation” may refer to an operation scheduled to be performed during a (e.g., current) maintenance session of a maintenance schedule (e.g., specified in a service manual). In contrast, an “unscheduled maintenance operation” or “unscheduled operation” may refer to a maintenance operation that is not scheduled to be performed during a current maintenance session and/or a maintenance operation that is not scheduled to be performed during any maintenance session of a maintenance schedule.

A “set” may include one or more objects (e.g., a “set” of maintenance operations can include one or more maintenance operations). Phrases herein may suggest a set includes multiple objects (e.g., “maintenance operations in the set”). However, phrases like this may be used for convenience and the “set” should not be interpreted to require multiple objects.

The operation descriptor receiver module 235 receives a set of one or more maintenance operation descriptors relating to maintenance for an aircraft. The set of maintenance operation descriptors may be received from the client device 110, a database (e.g., 251 and/or 150), the aircraft entity 140, another source, or any combination thereof.

A maintenance operation descriptor is data describing or indicating a maintenance operation for an aircraft (this may be referred to as an “input operation”). A maintenance operation descriptor may describe a scheduled or unscheduled operation. Example data types include text data (e.g., natural language text), audio data, image data, and video data. A received set of maintenance operation descriptors may include maintenance operation descriptors of different data types. The data may represent natural language (e.g., text or audio data including natural language).

A maintenance operation descriptor may describe (a) a maintenance operation to be performed on an aircraft, (b) a maintenance operation that has already been performed on an aircraft, (c) a maintenance operation that is being currently being performed on an aircraft. Example maintenance operations for an aircraft include inspecting a component of the aircraft, repairing a component of the aircraft, replacing a component of the aircraft, and any combination thereof.

A maintenance operation descriptor may be provided or generated in many ways. For example, a user types (or selects) details of a maintenance operation via a user interface of application 111, and the text is transmitted from the client device 110 to the operation descriptor receiver module 235 (for example, a user types “perform inspection of wing component,” “replace rotor component,” “main landing gear detailed inspection,” “emergency brake system detailed inspection,” “rudder and rudder trim detailed inspection and functional check.” In another example, a user selects a maintenance package that includes multiple maintenance operations (e.g., a maintenance package specified in a service manual for the aircraft e.g., an annual inspection maintenance package) and text from those operations are transmitted to the operation descriptor receiver module 235. In another example, a user performs a maintenance operation on the aircraft while wearing a camera that captures images or records video of the operation being performed (e.g., the user is wearing an augmented reality or virtual reality headset). The captured images or video feed from the camera is then transmitted (e.g., later or in real-time) to the operation descriptor receiver module 235. In another example, a operation descriptor is sensor data from a sensor of an aircraft (e.g., if the sensor data indicate a potential issue to be fixed via a operation) such as, for example, aircraft entity 140. Operation descriptors can be provided from other sources as well, such as service manuals (e.g., specifying operations for different maintenance sessions in a maintenance schedule), training manuals, service reports, work orders (these may be stored in the maintenance log 251 and/or one or more source databases 150), or any combination thereof. If a source includes multiple maintenance operations (e.g., a work order lists multiple operations or an audio clip describes multiple operations), the operation descriptor receiver module 235 may separate the operations (however in other embodiments, the operations may not be separated).

The volume and type of maintenance operation descriptors received by the operation descriptor receiver module 235 may depend on whether the aircraft maintenance module 130 is being used to generate a graph object or used to generate a operation recommendation. For example, if a user is using the aircraft maintenance module 130 to generate a operation recommendation, the operation descriptor receiver module 235 may receive operation descriptors describing a few operations the user is intending to perform on an aircraft (e.g., a operation descriptor describing a single operation or a set of operation descriptors describing a maintenance package). However, if the aircraft maintenance module 130 is being used to generate a graph object, the operation descriptor receiver module 235 may receive operation descriptors for a large number of operations (e.g., to generate a robust graph object with many different clusters). For example, to generate a graph the operation descriptor receiver module 235 receives operation descriptors from service manuals, training manuals, service reports, and work orders.

The operation descriptor receiver module 235 receiving a set of operation descriptors can include the operation descriptor receiver module 235 retrieving one or more operation descriptors from various sources. For example, the operation descriptor receiver module 235 retrieves maintenance logs associated with an aircraft and stored in the maintenance log 251. The maintenance log 251 stores logs (e.g., completed work orders) of maintenance operations that were previously performed on the aircraft (or similar aircraft e.g., same type or model)). Maintenance log 251 may receive information from one or more source databases 150). The operation descriptor receiver module 235 may scan the maintenance logs for operations (e.g., notes or observations on the aircraft relating to or suggesting operations that should be performed in the future). For example, a log may observe that a component is functional but looks worn and may need to be replaced in the future.

The operation descriptor receiver module 235 may also receive information identifying the aircraft. This information may be passed to other modules of the aircraft maintenance module 130 to generate a maintenance recommendation and/or generate a graph object. The information may include the manufacturer and the aircraft model type. The information may additionally, or alternatively, include information unique to the specific aircraft, such as the aircraft's registration number, serial number, year of manufacture, or any combination thereof.

The operation embedder module 237 receives the set of one or more maintenance operation descriptors from the operation descriptor receiver module 235 and transforms the set of operation descriptors into a set of one or more embedding vectors. The operation embedder module 237 may generate a vector for each operation in the set.

An embedding vector is a form of vector representation where input data (e.g., text, images, video, audio) are mapped to vectors of numbers (e.g., high dimensional vectors). It transforms high-dimensional data into a lower-dimensional space that is simpler to work with. Thus, embedding vectors can preserve the semantic meaning and relationship of the original input data. For example, words that are similar in meaning or that often occur together in the lexicon have similar embedding vectors. Thus, among other advantages the operation descriptor receiver module 235 and operation embedder module 237 enable operation normalization of operation descriptions that may be from different sources and that may use different formats.

The clustering module 257 receives embedding vectors from the operation embedder module 237 and groups the vectors into clusters according to vector similarity. Thus, the clustering module 257 forms clusters of embedding vectors, where embedding vectors in a cluster (e.g., all embedding vectors in each cluster) represent the same operation. Thus, each cluster may represent a (e.g., unique) maintenance operation for an aircraft. The operation represented by each cluster may be referred to as a “known operation.” Depending on a given received vector, the clustering module 257 may generate a new cluster for that vector (e.g., if a cluster for a known operation does not exist yet) or it may group that vector into an already existing cluster (e.g., if a cluster for a known operation already exists). The clustering may be performed by an unsupervised machine learning model, such as a k-means clustering model.

The clustering module 257 can be considered a deduplicator because different maintenance operation descriptors describing the same operation (e.g., using different words, terminologies, or phraseologies) may be grouped into the same cluster (more specifically, the embedding vectors representing those different operation descriptors may be grouped into the same cluster). Among other advantages, the clustering module 257 enables users to describe operations according to their preferred terminology or personal preference. For example, a first user describes a maintenance operation as “inspect nose landing gear” and a second user describes that operation as “perform inspection of landing gear.” (Similarly, different operations with similar words or phraseologies may be grouped into different clusters. For example, even though “perform inspection of nose landing gear,” “nose landing gear,” and “landing gear” have similar words and phraseologies, clustering module 257 may group the corresponding vectors into different clusters (e.g., since there is also main landing gear)). Due to the clustering module 257, vectors representing each of those operation descriptors may be grouped into the same cluster. Similarly, the clustering module 257 enables users to describe operations in their preferred method. For example, if a first user prefers to type a maintenance operation but another user prefers to record their voice describing the operation, vectors representing each of those operation descriptors may also be grouped into the same cluster.

Among other advantages, by deduplicating, the clustering module 257 reduces the computational resources used by the system (e.g., to generate a graph object or maintenance recommendation). For example, the clustering module 257 results in smaller graph objects (graph objects are further described below), which results in fewer nodes and edge weights (as generating a graph object with a node for each operation descriptor). Thus, instead of determining correlations between each maintenance operation descriptor and resulting maintenance operation, correlations can be determined between the smaller set of clusters and the resulting operations.

The graph generator module 255 can generate and update graph objects. Graph objects generated by the graph generator module 255 may be stored in graph database 253. A graph object is a collection of nodes (also “vertices”) connected by edges. Each node is a cluster or represents a cluster generated by the clustering module 257. Thus, each node represents a known maintenance operation.

An edge of a graph object connects two nodes. An edge includes a weight. The weight represents the correlation between the known maintenance operations of the nodes (also referred to as “relatedness”). For example, if a first node represents a first known operation and a second node represents a second known operation, the weight between those nodes represents the likelihood that the first known operation is performed given the second known operation has already occurred or will be performed or the other way around. In another example, the weight between those nodes depends on the second operation occurring while performing the first operation (e.g., the graph is a directed graph). As used herein, a larger weight may represent a stronger correlation and a smaller weight may represent a weaker correlation. However, this is merely for convenience and other conventions may be used. For example, a smaller weight may represent a stronger correlation.

The graph generator module 255 may generate a weight of an edge based on “operation similarity,” “operation closeness during maintenance session,” “operation closeness to other maintenance session,” “operation closeness temporality,” or any combination thereof. These metrics are further described below.

Operation Similarity. This indicates the similarity of a first embedding vector relative to one or more embedding vectors of clusters. In some embodiments, the vectors themselves are compared, while in some other embodiments, operation descriptors are compared. For example, the following operation descriptors “inspect landing gear” and “find corrosion of landing gear” have a high text similarity, which may result in those operations having a strong correlation.

Operation closeness during a maintenance session. Whether maintenance operations are completed during the same maintenance session (e.g., recorded on the same work order or service report) may affect the edge weight between those operations. Generally, operations completed during the same maintenance session have a stronger correlation (e.g., and thus result in larger edge weights).

Operation closeness to other maintenance sessions. The closeness to other work orders that may have performed the same or similar tasks. If more work orders have similar tasks, the higher the weight. For example, if the same type of work has happened in many work orders, they may have a stronger relationship.

Operation closeness temporality. The duration of time between when maintenance operations are performed may affect the edge weight between those operations. Generally, shorter time durations between when operations are performed have stronger correlations (e.g., and thus result in larger edge weights). For example, operations recorded as completed on work orders (or service reports) that are dated closer to each other have a stronger correlation than operations recorded as completed on work orders (or service reports) that are dated farther from each other. Additionally, or alternatively, the closeness to other maintenance session, may refer to the number of maintenance sessions between when operations are performed. Generally, fewer maintenance sessions between when maintenance operations are performed have stronger correlations (e.g., and thus result in larger edge weights). For example, operations typically recorded on work orders (or service reports) during subsequent or prior maintenance sessions have a have a stronger correlation than operations typically recorded on work orders (or service reports) that are separated by multiple maintenance sessions.

The individual contributions of the above metrics to the weight of an edge may be equal or different. For example, the metric values are weighted differently.

The graph generator module 255 may generate a single graph object that correlates maintenance operations for many different aircraft. Alternatively, the graph generator module 255 may generate multiple graph objects. For example, the graph generator module 255 generates a graph object for aircraft made by the same aircraft manufacturer (e.g., a graph object for each manufacturer). In another example, the graph generator module 255 generates graph objects for aircraft models (e.g., a graph object for each aircraft model). Graph objects that are more specific (e.g., per manufacturer or per aircraft model) may be more accurate for predicting accurate operation recommendations. In some embodiments, graphs are generated for a user (e.g., based on the aircraft they service) or an instance of a graph object is generated for a user.

As previously stated, a user may be an individual (e.g., a technician or mechanic), a maintenance entity (e.g., company), or an airline.

In some embodiments, resultant operation generator module 243 modifies weights of a graph object after the graph object is generated (e.g., resultant operation generator module 243 re-wights the graph edges). For example, if a user (e.g., an individual, a maintenance entity, or an airline) typically does not typically perform a resultant operation (in a recommendation) that was determined based on a given known operation, the weighting between the resultant operation and the known operation may be adjusted to reduce the correlation between them. The weight adjustment may be performed on a graph object used only by that user (e.g., it was generated for that user).

In some embodiments, resultant operation generator module 243 generates weights or adjusts weights of a graph object based on when operations should be performed (e.g., which maintenance session). For example, if a given operation is preferred to be performed during a specific maintenance session (e.g., due to time, cost, and/or labor to perform that operation), weights may be adjusted such that correlations between the given operation and other operations that are typically performed during that specific maintenance session may be increased. For example, since annual inspections tend to be more thorough and technicians tend to have more time to service aircraft, it may be preferrable to perform involved operations during annual inspections (e.g., operations that require more time, cost, and/or labor).

The resultant operation generator module 243 determines a set of operations using a graph object (e.g., stored in graph database 253). Operations in the set may be referred to as “resultant operations.” The input for the resultant operation generator module 243 is provided by the clustering module 257. As previously described, (a) the clustering module 257 receives embedding vectors and groups the vectors into a set of clusters and (b) each of the clusters in the set represent a known operation. Thus, the input for the resultant operation generator module 243 is an indication (e.g., a list) of the set of known operations associated with the set of clusters that the embedding vectors were grouped into by the clustering module 257. For example, the clustering module 257 transmits the set of clusters themselves, an indication (e.g., a list) of the set of clusters, the set of known operations associated with the set of clusters, or any combination thereof.

More generally, the resultant operation generator module 243 receives a set of known operations from the clustering module 257 and determines a set of resultant operations from the set of known operations, where each of the resultant operations in the set has at least a threshold correlation with at least one of the known operations. To do this, the resultant operation generator module 243 may traverse a graph object and analyze edge weights to identify operations with at least the threshold correlation. To give a specific example, for a known operation associated with a first node of a graph object, the resultant operation generator module 243 analyzes edges connecting the first node to other nodes in the graph object. If a weight of an edge corresponds to at least the threshold correlation, then the corresponding node is determined represent a resultant operation.

The recommendation generator module 245 receives a set of resultant operations from the resultant operation generator module 243 and generates a recommendation that recommends maintenance operations to be performed on the aircraft. The recommendation generator module 245 may be the same module as the resultant operation generator module 243. The recommendation includes at least one of the resultant operations from the resultant operation generator module 243. In some embodiments, the recommendation includes all of the resultant operations from the resultant operation generator module 243. The recommendation may be sent to the device or component (e.g., client device 110) that provided the input operations (via operation descriptors).

A recommendation from the recommendation generator module 245 may also include one or more scores for a recommended operation. A operation score is intended to help a user determine whether they should perform the operation. A operation may help a user understand the relationship between the recommended operation and an input operation (described by the operation descriptor they originally provided). In some embodiments, the resultant operations are ranked according to their scores. The recommendation may include the top ranked operations and not include the remaining resultant operations (e.g., a threshold number of top ranked resultant operations are included in the recommendation).

A first example score indicates the strength of correlation (e.g., as indicated by an edge weight) between the recommended operation and an input operation. In another example, the score represents the likelihood that the recommended operation is performed given the input operation was performed, where the likelihood is generated based on the data (e.g., operation descriptors) used to generate the underlying graph object. In another example, the score indicates the importance of the recommended operation (e.g., for the aircraft to operate safely). In another example, the score indicates the likelihood of a component failure if the recommended operation is not performed. In another example, if a score is for operation related to inspecting a component, the score indicates the likelihood the component is faulty. In another example, the score indicates the percentage of users who, when the aircraft maintenance module 130 recommended the operation, chose to perform the recommended operation. In this example, the recommendation generator module 245 includes a model that may track user responses to recommendations from the aircraft maintenance module 130 (in accordance with user permissions (e.g., user responses are anonymized)). Additionally, or alternatively, the model is a machined learned model trained based on user responses to recommendations from the aircraft maintenance module 130 (in accordance with user permissions (e.g., user responses are anonymized)).

The resulting operations received from the resultant operation generator module 243 may include scheduled and unscheduled operations. In these situations, the recommendation may distinguish between the scheduled and unscheduled operations. For example, the recommendation includes unscheduled operations and filters out the scheduled operations (e.g., because identifying unscheduled operations may be more valuable to the user and the user may already know the maintenance operations). In another example, the recommendation labels maintenance operations as scheduled or unscheduled. If a maintenance operation is scheduled, the recommendation may further specify which maintenance session(s) that operation is part of.

Distinguishing between scheduled and unscheduled maintenance operations can be performed in multiple ways. For example, known maintenance operations of a graph object may be marked as scheduled or unscheduled (e.g., by an administrator or a machine learning model). In another example, during a graph generation process (e.g., FIG. 3A), the input operation descriptors may indicate whether the operations are scheduled or unscheduled. In some other examples, a trained machine learned model can be used. For example, a machine learned model can be trained to determine whether a maintenance operation descriptor is describing a scheduled or unscheduled operation. This may be possible because operation descriptors for scheduled operations tend to be phrased in a recognizable manner (since many of them are from service manuals). Additionally, schedule maintenance operations tend to use the same phraseology or key words (e.g., “inspect” is a common word for operation descriptors of scheduled operations and “found” is a common word for operation descriptors of unscheduled operations). A machine learned module may additionally, or alternatively analyze the correlation strength between known operations in a graph object to determine whether a operation is scheduled or not since schedule operations tend to have high correlations with each other (since they are regularly performed together). Thus, the machine learned model may determine that operations with a correlation strength above a threshold are likely scheduled operations but operations with a correlation strength below the threshold (or another threshold) are likely unscheduled operations.

FIG. 3A is a flow chart for generating a graph object 317 using modules of the aircraft maintenance module 130. The graph object 317 may be used later to generate a maintenance recommendation (e.g., as described with respect to FIG. 3B). As depicted, a operation embedder module 237 receives operation descriptors 311 describing maintenance operations for an aircraft (e.g., from the descriptor receiver module 235). The operation embedder module 237 generates embedding vectors 313 representing the operation descriptors (e.g., an embedding vector for each of the operation descriptors). The clustering module 257 receives the embedding vectors 313 and groups the vectors into clusters 315, where each cluster represents one of the maintenance operations for the aircraft. The graph generator module 255 generates a graph object 317 by determining weights for edges (e.g., 319) between clusters. The weights represent the correlation between maintenance operations of the clusters. The graph object 317 may be stored in the graph database 253.

FIG. 3B is a flow chart for generating a maintenance recommendation for an aircraft using modules of the aircraft maintenance module 130. The flow chart of FIG. 3B assumes the graph object 317 of FIG. 3A was previously generated. As depicted, a operation embedder module 237 receives a set of operation descriptors 321 describing maintenance operations for an aircraft (as previously described, the set may include a single operation descriptor, but this example assumes the set includes multiple descriptors describing multiple operations). The operation embedder module 237 generates embedding vectors 323 representing the operation descriptors (e.g., an embedding vector for each of the operation descriptors).

The clustering module 257 receives the embedding vectors 323 and determines which clusters 315 of graph object 317 the embedding vectors 323 belong to. For example, the clustering module 257 groups (e.g., adds) the embedding vectors 323 to clusters 315 of graph object 317. Known operations 325 representing the clusters identified by the clustering module 257 are transmitted to the resultant operation generator module 243. The resultant operation generator module 243 determines a set of resultant operations using the weights of the graph object 317. The resultant operations are then used to generate a maintenance recommendation, for example, by the recommendation generator module 245.

In some embodiments, aircraft maintenance module 130 includes a normalization module. The normalization module receives an operation descriptor (e.g., 311 or 321) from operation descriptor receiver module 235, performs one or more normalization operations to the descriptor, and provides the resulting normalized descriptor to operation embedder module 237. A normalization operation may modify an operation descriptor such that it includes language, terminology, phraseology, or any combination thereof that is consistent with or similar to other operation descriptors (e.g., describing the same maintenance operations). For example, operation descriptors describing the same maintenance operation using different terminology may be normalized to use the same or similar terminology. Among other advantages, normalized descriptors may result in improved clustering of the corresponding embedding vectors 313 and/or determination of known operations 325 from embedding vectors 323. The normalization module may use a natural language processing (NLP) model or algorithm or a large language model (LLM). For example, an LLM of the normalization module is prompted to normalize an operation descriptor. The normalization module can be used during the process of graph generation (e.g., FIG. 3A) and/or for generating a maintenance recommendation (e.g., FIG. 3B).

In some embodiments, aircraft maintenance module 130 includes an operation categorization module. The operation categorization module receives an embedding vector (e.g., 313) and assigns an operation category to it. For example, the operation categorization module may categorize an embedding vector as corresponding to an operation (e.g., an inspection) or a non-operation (e.g., an administrative task) (other categorizes are possible). The operation categorization module may be a trained model (e.g., using embedding vectors labeled with categories as training data). A operation category may be used by clustering module 257 for improved cluster generation from embedding vectors and/or may be used by graph generator module 255 for improved graph object generation. For example, if a graph object (e.g., 317) should not include administrative tasks (e.g., administrative tasks are not useful for generating operation recommendations), then embedding vectors 313 categorized as administrative tasks may be disregarded by clustering module 257 or graph generator module 255.

In some embodiments, aircraft maintenance module 130 includes a cluster classifier module configured to associate input with a part or area of an aircraft. More specifically, since a cluster represents an operation, the cluster classifier module is configured to determine which part or area of the aircraft that operation is associated with. For example, the cluster classifier module may determine a cluster for an inspection operation specifically relates to a rotor inspection. The cluster classifier module can receive a cluster (e.g., 315) or a portion of a cluster (e.g., an embedding vector of the cluster or the cluster centroid) as input and output an area or part of an aircraft. Among other advantages, the cluster classification may be used by graph generator module 255 for improved graph object generation (e.g., weights for the edges are based on the classifications by the cluster classifier module). The cluster classifier module may be applied to individual embedding vectors to apply classifications to those individual vectors (in addition to or instead of entire clusters). For example, during the recommendation generation process (e.g., FIG. 3B), a classification by the cluster classification module may be used for improved determination of known operations 325 by clustering module 257.

Referring back to FIG. 2, the aircraft maintenance module 130 may be useful in many different contexts and situations. In a first example, an aircraft is due for scheduled maintenance and a user inputs one or more scheduled maintenance operations (e.g., specified in a service manual) into the aircraft maintenance module 130to determine if the aircraft maintenance module 130 recommends performing any additional (e.g., unscheduled) maintenance operations on the aircraft.

In another example, if an aircraft service provider is determining an amount of labor, materials, etc. needed to perform maintenance on an aircraft, a user of the aircraft service provider may use the aircraft maintenance module 130 to determine if there will be additional (e.g., unforeseen) maintenance operations that should be performed on the aircraft (e.g., the user inputs maintenance operations they are planning to perform on the aircraft to determine if there will be additional (e.g., unforeseen) operations that should be performed). In a similar example, if an aircraft service provider is bidding to perform maintenance on an aircraft, it may use the aircraft maintenance module 130 to improve its cost estimate for performing that maintenance.

In another example, the aircraft maintenance module 130 can help a user (e.g., an aircraft technician or mechanic) solve an issue on an aircraft (e.g., in real-time) and/or the aircraft maintenance module 130 can help train users how to maintain an aircraft (e.g., in real-time), especially for maintenance operations not specified in a service manual. For example, a user provides conditions (e.g., an issue) of an aircraft to receive operation recommendations for addressing those conditions. In another example, a user provides inspections they are performing to receive operation recommendations for other inspections to perform. In another example, a user inspecting an aircraft is wearing a camera (e.g., an augmented reality headset or a virtual reality headset) that is capturing images or videos. Aircraft maintenance module 130 receives the images or videos and outputs a maintenance recommendation based on the images or videos. The recommendation may be presented to the user via augmented or virtual reality content. For example, augmented reality indicators instruct a user to replace a component (e.g., replace a leaky hose). In a specific example, a user is wearing headset that, in real time and using aircraft maintenance module 130, detects problems using computer vision and outputs recommendations (e.g., using augmented reality (e.g., “this component is corroded” or “check this connector”)).

In some embodiments, parts for maintenance operations are (e.g., automatically) requested (e.g., to be retrieved from storage) or ordered (e.g., purchased from another entity) based on resultant operations from resultant operation generator module 243. For example, if a score for a resultant operation is above a threshold (e.g., the likelihood of a component failure is above a threshold), a part for that operation is requested or ordered.

### COMPUTING MACHINE ARCHITECTURE

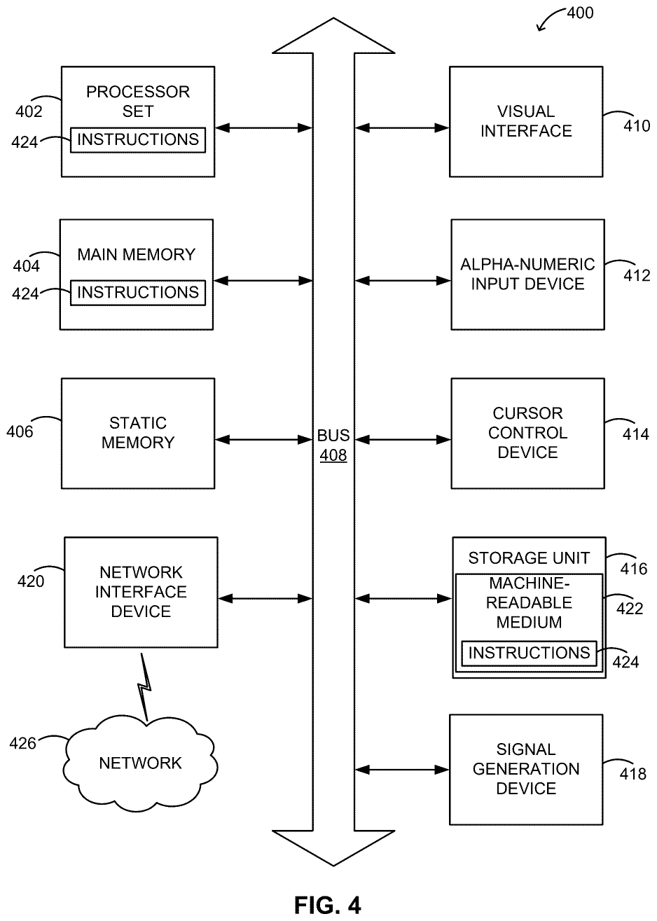

FIG. 4 is a block diagram illustrating components of an example machine able to read instructions from a machine-readable medium and execute them in a set of one or more processors (or controllers). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor set 402 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any combination of these), a main memory 404, and a static memory 406, which are configured to communicate with each other via a bus 408. If the processor set 402 includes multiple processors, the processors may operate collectively or individually. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### EXEMPLARY PROCESS GENERATING AIRCRAFT MAINTENANCE RECOMMENDATION

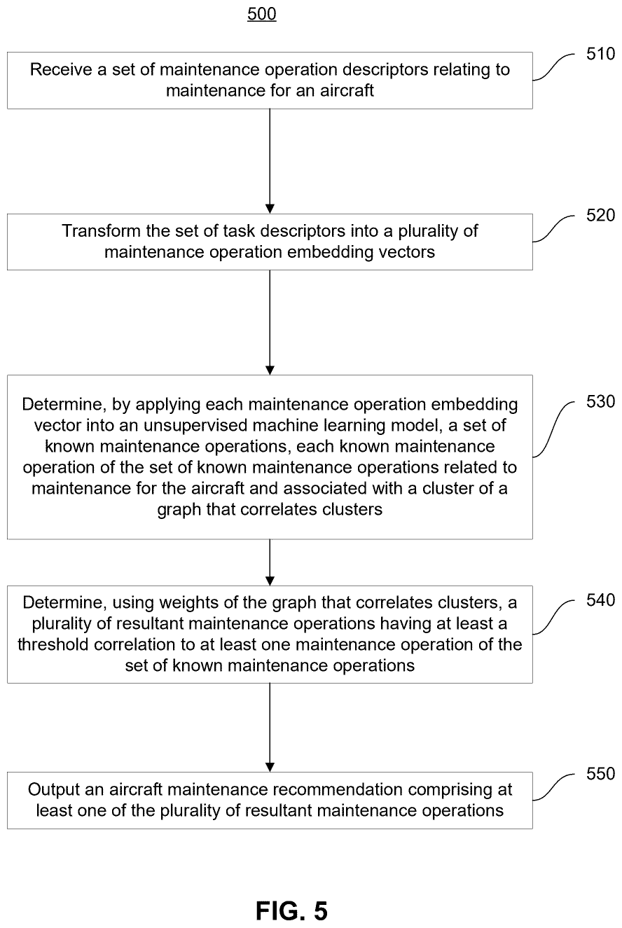

FIG. 5 is a flowchart of an example method for 500 for generating an aircraft maintenance recommendation. In the example of FIG. 5, the method 500 is performed from the perspective of the aircraft maintenance module 130. The method 500 can include additional or fewer steps than described herein. Additionally, the steps can be performed in different order or by different components than described herein. In some embodiments, the method 500 is performed by a computing system (e.g., 400) executing code stored on a (e.g., non-transitory) computer-readable storage medium that causes the computing system to perform the steps of method 500.

At step 510, the aircraft maintenance module 130 (e.g., via the operation descriptor receiver module 235) receives a set of maintenance operation descriptors (e.g., 321) relating to maintenance for an aircraft (e.g., 140). The maintenance operation descriptors may come from one or more databases (e.g., 150).

At step 520, the aircraft maintenance module 130 (e.g., via the operation embedder module 237) transforms the set of maintenance operation descriptors into a plurality of maintenance operation embedding vectors (e.g., 323).

At step 530, the aircraft maintenance module 130 (e.g., via the clustering module 257) determines, by applying each maintenance operation embedding vector into an unsupervised machine learning model, a set of known maintenance operations (e.g., 325). Each known maintenance operation of the set of known maintenance operations relates to maintenance for the aircraft and is associated with a cluster of a graph that correlates clusters (e.g., 317). The graph may include clusters of known maintenance operations for maintaining the aircraft.

At step 540, the aircraft maintenance module 130 (e.g., via the resultant operation generator module 243) determines, using weights of the graph that correlates clusters, a plurality of resultant maintenance operations (e.g., 327) having at least a threshold correlation to at least one maintenance operation of the set of known maintenance operations.

At step 550, the aircraft maintenance module 130 (e.g., via the recommendation generator module 245) outputs an aircraft maintenance recommendation comprising at least one of the plurality of resultant maintenance operations. The recommendation may include a score for the at least one of the plurality of resultant maintenance operations, where the score indicates a percentage of users who, when the at least one of the plurality of resultant maintenance operations is recommended to them, choose to perform the at least one of the plurality of resultant maintenance operations. In some embodiments, the score is generated by a machine learned model trained based on user responses to recommendations.

In some embodiments, the recommendation includes a score for the at least one of the plurality of resultant maintenance operations, where the score indicates a likelihood of a component failure if the at least one of the plurality of resultant maintenance operations is not performed.

In some embodiments, the recommendation includes a probability of an issue associated with the at least one of the plurality of resultant maintenance operations being present on the aircraft.

The set of maintenance operation descriptors may relate to maintenance operations to be performed during a maintenance session for the aircraft. Outputting the aircraft maintenance recommendation may include: determining which maintenance operations of the plurality of resultant maintenance operations are scheduled maintenance operations for the maintenance session and which maintenance operations are unscheduled for the maintenance session; and outputting the unscheduled maintenance operations in the recommendation. In some embodiments, determining which maintenance operations of the plurality of resultant maintenance operations are scheduled maintenance operations for the maintenance session and which maintenance operations are unscheduled for the maintenance session comprises applying the set of maintenance operation descriptors to a model trained to identify scheduled and unscheduled maintenance operations according to phraseologies in the maintenance operation descriptors.

In some embodiments, the graph (e.g. 317) is generated by a method comprising: receiving a second set off maintenance operation descriptors (e.g., 311) relating to maintenance for the aircraft; transforming the second set of maintenance operation descriptors into a plurality of second maintenance operation embedding vectors (e.g., 313); grouping, by applying each of the second maintenance operation embedding vector into the unsupervised machine learning model, the second maintenance operation embedding vectors into clusters (e.g., 315), where each cluster represents a maintenance operation for the aircraft; and determining weights for edges (e.g. 319) between the clusters, wherein the weights represent correlations between the maintenance operations represented by the clusters.

In some embodiments, the method further includes applying each maintenance operation embedding vector into a classification machine learning module (e.g., the cluster classifier module), the classification machine learning module configured to receive a maintenance operation embedding vector and determine a part or area of the aircraft associated with the maintenance operation of the maintenance operation embedding vector, wherein the unsupervised machine learning model is configured to additionally receive determinations from the classification machine learning module, and wherein determining the a set of known maintenance operations further comprises applying determinations from the classification machine learning module into the unsupervised machine learning model.

Other aspects include components, devices, systems, improvements, methods, processes, applications, computer readable mediums, and other technologies related to any of the above.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code embodied on a machine-readable medium or in a transmission signal) and/or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times.

Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by a set of one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).) The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein.

Various modifications, changes and variations, which will be apparent to those skilled in the art, may be made in the arrangement, operation and details of the method and apparatus disclosed herein without departing from the spirit and scope defined in the appended claims. References to “aircraft” components are exemplary throughout, and the components may be part of any other composition or vehicle wherever “aircraft” is stated herein.

1. A method comprising:
receiving a set of maintenance operation descriptors comprising natural language text descriptions of maintenance operations scheduled to be performed during a current or upcoming maintenance session for an aircraft;
transforming the natural language text descriptions of the set of maintenance operation descriptors into a plurality of maintenance operation embedding vectors;
determining, by applying each maintenance operation embedding vector into an unsupervised machine learning model, a set of known maintenance operations, each known maintenance operation of the set of known maintenance operations related to maintenance for the aircraft and associated with a cluster of a graph that correlates clusters;
determining, using weights of the graph that correlates clusters, a plurality of resultant maintenance operations having at least a threshold correlation to at least one maintenance operation of the set of known maintenance operations; and
outputting an aircraft maintenance recommendation to perform at least one of the plurality of resultant maintenance operations during the current or upcoming maintenance session for the aircraft, the at least one of the plurality of resultant maintenance operations being an unscheduled maintenance operation for the current or upcoming maintenance session.

2. The method of claim 1, wherein outputting the aircraft maintenance recommendation comprises:
determining which maintenance operations of the plurality of resultant maintenance operations are scheduled maintenance operations for the maintenance session and which maintenance operations are unscheduled for the maintenance session; and
outputting the unscheduled maintenance operations in the recommendation.

3. The method of claim 2, wherein determining which maintenance operations of the plurality of resultant maintenance operations are scheduled maintenance operations for the maintenance session and which maintenance operations are unscheduled for the maintenance session comprises applying the set of maintenance operation descriptors to a model trained to identify scheduled and unscheduled maintenance operations according to phraseologies in the maintenance operation descriptors.

4. The method of claim 1, wherein the recommendation includes a score for the at least one of the plurality of resultant maintenance operations, wherein the score indicates a percentage of users who, when the at least one of the plurality of resultant maintenance operations is recommended to them, choose to perform the at least one of the plurality of resultant maintenance operations.

5. The method of claim 4, wherein the score is generated by a machine learned model trained based on user responses to recommendations.

6. The method of claim 1, wherein the recommendation includes a score for the at least one of the plurality of resultant maintenance operations, wherein the score indicates a likelihood of a component failure if the at least one of the plurality of resultant maintenance operations is not performed.

7. The method of claim 1, wherein the graph includes clusters of known maintenance operations for maintaining the aircraft.

8. The method of claim 1, wherein the recommendation further comprises a probability of an issue associated with the at least one of the plurality of resultant maintenance operations being present on the aircraft.

9. The method of claim 1, further comprising generating the graph, wherein generating the graph comprises
receiving a second set of maintenance operation descriptors relating to maintenance for the aircraft;
transforming the second set of maintenance operation descriptors into a plurality of second maintenance operation embedding vectors;
grouping, by applying each of the second maintenance operation embedding vectors into the unsupervised machine learning model, the second maintenance operation embedding vectors into clusters, where each cluster represents a maintenance operation for the aircraft; and
determining weights for edges between the clusters, wherein the weights represent correlations between the maintenance operations represented by the clusters.

10. The method of claim 1, further comprising:
applying each maintenance operation embedding vector into a classification machine learning module, the classification machine learning module configured to receive a maintenance operation embedding vector and determine a part or area of the aircraft associated with the maintenance operation of the maintenance operation embedding vector,
wherein the unsupervised machine learning model is configured to additionally receive determinations from the classification machine learning module, and
wherein determining the set of known maintenance operations further comprises applying determinations from the classification machine learning module into the unsupervised machine learning model.

11. A non-transitory computer-readable medium comprising memory with instructions encoded thereon that, when executed by a computing system, cause the computing system to perform processes comprising:
receiving a set of maintenance operation descriptors comprising natural language text descriptions of maintenance operations scheduled to be performed during a current or upcoming maintenance session for an aircraft;
transforming the natural language text descriptions of the set of maintenance operation descriptors into a plurality of maintenance operation embedding vectors;
determining, by applying each maintenance operation embedding vector into an unsupervised machine learning model, a set of known maintenance operations, each known maintenance operation of the set of known maintenance operations related to maintenance for the aircraft and associated with a cluster of a graph that correlates clusters;
determining, using weights of the graph that correlates clusters, a plurality of resultant maintenance operations having at least a threshold correlation to at least one maintenance operation of the set of known maintenance operations; and
outputting an aircraft maintenance recommendation to perform at least one of the plurality of resultant maintenance operations during the current or upcoming maintenance session for the aircraft, the at least one of the plurality of resultant maintenance operations being an unscheduled maintenance operation for the current or upcoming maintenance session.

12. The non-transitory computer-readable medium of claim 11, wherein outputting the aircraft maintenance recommendation comprises:
determining which maintenance operations of the plurality of resultant maintenance operations are scheduled maintenance operations for the maintenance session and which maintenance operations are unscheduled for the maintenance session; and
outputting the unscheduled maintenance operations in the recommendation.

13. The non-transitory computer-readable medium of claim 12, wherein determining which maintenance operations of the plurality of resultant maintenance operations are scheduled maintenance operations for the maintenance session and which maintenance operations are unscheduled for the maintenance session comprises applying the set of maintenance operation descriptors to a model trained to identify scheduled and unscheduled maintenance operations according to phraseologies in the maintenance operation descriptors.

14. The non-transitory computer-readable medium of claim 11, wherein the recommendation includes a score for the at least one of the plurality of resultant maintenance operations, wherein the score indicates a percentage of users who, when the at least one of the plurality of resultant maintenance operations is recommended to them, choose to perform the at least one of the plurality of resultant maintenance operations.

15. The non-transitory computer-readable medium of claim 14, wherein the score is generated by machine learned model trained based on user responses to recommendations.

16. The non-transitory computer-readable medium of claim 11, wherein the recommendation includes a score for the at least one of the plurality of resultant maintenance operations, wherein the score indicates a likelihood of a component failure if the at least one of the plurality of resultant maintenance operations is not performed.

17. The non-transitory computer-readable medium of claim 11, wherein the graph includes clusters of known maintenance operations for maintaining the aircraft.

18. The non-transitory computer-readable medium of claim 11, wherein the recommendation further comprises a probability of an issue associated with the at least one of the plurality of resultant maintenance operations being present on the aircraft.

19. The non-transitory computer-readable medium of claim 11, further comprising generating the graph, wherein generating the graph comprises:
receiving a second set off maintenance operation descriptors relating to maintenance for the aircraft;
transforming the second set of maintenance operation descriptors into a plurality of second maintenance operation embedding vectors;
grouping, by applying each of the second maintenance operation embedding vector into the unsupervised machine learning model, the second maintenance operation embedding vectors into clusters, where each cluster represents a maintenance operation for the aircraft; and
determining weights for edges between the clusters, wherein the weights represent correlations between the maintenance operations represented by the clusters.

20. A system comprising:
memory with instructions encoded thereon; and
a system of one or more processors that, when executing the instructions, are caused to perform maintenance operations comprising:
receiving a set of maintenance operation descriptors comprising natural language text descriptions of maintenance operations scheduled to be performed during a current or upcoming maintenance session for an aircraft;
transforming the natural language text descriptions of the set of maintenance operation descriptors into a plurality of maintenance operation embedding vectors;
determining, by applying each maintenance operation embedding vector into an unsupervised machine learning model, a set of known maintenance operations, each known maintenance operation of the set of known maintenance operations related to maintenance for the aircraft and associated with a cluster of a graph that correlates clusters;
determining, using weights of the graph that correlates clusters, a plurality of resultant maintenance operations having at least a threshold correlation to at least one maintenance operation of the set of known maintenance operations; and
outputting an aircraft maintenance recommendation to perform at least one of the plurality of resultant maintenance operations during the current or upcoming maintenance session for the aircraft, the at least one of the plurality of resultant maintenance operations being an unscheduled maintenance operation for the current or upcoming maintenance session.
